(19) United States
(12) Patent Application Publication
(10) Pub. No.: US 2026/0164001 A1
(43) Pub. Date: Jun. 11, 2026

(54) INFORMATION PROCESSING DEVICE, PROGRAM, AND INFORMATION PROCESSING SYSTEM

(71) Applicant: SONY GROUP CORPORATION, TOKYO (JP)

(72) Inventors: MASAHIRO TAKE, TOKYO (JP); TAKASHI TSUCHIYA, TOKYO (JP)

(21) Appl. No.: 18/704,372

(22) PCT Filed: Oct. 31, 2022
(86) PCT No.: PCT/JP2022/040717

§ 371 Date: Apr. 24, 2024

(30) Foreign Application Priority Data
Nov. 1, 2021 (JP) 2021-178915
Aug. 1, 2022 (JP) 2022-122891

(51) Int. Cl. H04N 9/64; H04N 5/222

(52) U.S. Cl. CPC H04N 9/646; H04N 5/222; H04N 9/643

(57) ABSTRACT

An information processing device (100) of the present disclosure includes a control unit (130). The control unit (130) calculates a correction coefficient based on a first image obtained when a display image displayed on a display device (200) is captured by an imaging device (300B) and a second image obtained when the display image is captured by imaging device (300B) in an imaging environment. The correction coefficient is used to display a re-photographing image after correction on the display device (200) when the re-photographing image displayed on the display device (200) disposed in the imaging environment is captured by the imaging device (300B).

### FIELD

The present disclosure relates to an information processing device, a program, and an information processing system.

### BACKGROUND

In movie photographing and the like, there has been known a photographing system in which a performer performs a performance in front of a wall surface on which an image of computer graphics (CG) or the like is projected and the wall surface and the performer are simultaneously photographed to combine and photograph the CG image and the performer in real time.

### CITATION LIST

### Patent Literature

Patent Literature 1: US 2020/0145644 A

### SUMMARY

### Technical Problem

As explained above, when an image projected on a screen (for example, the wall surface) and an object (for example, the performer) are photographed by the same camera, an RGB value of an image obtained by photographing the image again (hereinafter also described as re-photographed image) and an RGB value of an image obtained by photographing the object (hereinafter also described as captured image) are sometimes different.

Specifically, for example, it is assumed that the image obtained by photographing the performer is projected on the wall surface and the performer of the same person performs a performance in front of the wall surface (a real space) and photographing is performed. In this case, a color (an RGB value) of a re-photographed image of the performer in the image and a color (an RGB value) of a photographed image of the actual performer in front of the wall surface are sometimes different.

This is because spectral characteristics of the object in the real space and spectral characteristics of the image displayed on the screen are different. Therefore, for example, even if the screen and the object in the real space are simultaneously photographed, it cannot be said that an image with high reality (realistic feeling) can be obtained.

Therefore, it is desirable to align the RGB values of the re-photographed image and the RGB values of the photographed image of the real space and photograph an image with higher reality.

Therefore, the present disclosure provides a mechanism that can acquire an image with higher reality.

Note that the problem or the object explained above are merely one of a plurality of problems or objects that can be solved or achieved by a plurality of embodiments disclosed in the present specification.

### Solution to Problem

An information processing device of the present disclosure includes a control unit. The control unit calculates a correction coefficient based on a first image obtained when a display image displayed on a display device is captured by an imaging device and a second image obtained when the display image is captured by imaging device in an imaging environment. The correction coefficient is used to display a re-photographing image after correction on the display device when the re-photographing image displayed on the display device disposed in the imaging environment is captured by the imaging device.

### BRIEF DESCRIPTION OF DRAWINGS

FIG. 1 is a diagram for explaining an overview of an information processing system according to an embodiment of the present disclosure.

FIG. 2 is a diagram for explaining an example of a real object photographed image.

FIG. 3 is a diagram for explaining an example of a display photographed image.

FIG. 4 is a diagram illustrating an example of an overview of calibration.

FIG. 5 is a diagram illustrating an example of information processing according to the embodiment of the present disclosure.

FIG. 6 is a diagram for explaining an example of correction coefficient calculation processing according to the embodiment of the present disclosure.

FIG. 7 is a diagram for explaining another example of the correction coefficient calculation processing according to the embodiment of the present disclosure.

FIG. 8 is a diagram for explaining a first application example of a correction coefficient according to the embodiment of the present disclosure.

FIG. 9 is a diagram for explaining a second application example of the correction coefficient according to the embodiment of the present disclosure.

FIG. 10 is a diagram for explaining a third application example of the correction coefficient according to the embodiment of the present disclosure.

FIG. 11 is a diagram for explaining an example of first correction coefficient calculation processing according to the embodiment of the present disclosure.

FIG. 12 is a diagram for explaining an example of second correction coefficient calculation processing according to the embodiment of the present disclosure.

FIG. 13 is a diagram for explaining an application example of first and second correction coefficients according to the embodiment of the present disclosure.

FIG. 14 is a diagram illustrating an example of calibration information presented by an information processing device according to the embodiment of the present disclosure.

FIG. 15 is a diagram illustrating another example of the calibration information presented by the information processing device according to the embodiment of the present disclosure.

FIG. 16 is a diagram illustrating another example of the calibration information presented by the information processing device according to the embodiment of the present disclosure.

FIG. 17 is a diagram illustrating an example of a color chart according to the embodiment of the present disclosure.

FIG. 18 is a block diagram illustrating a configuration example of the information processing device according to the embodiment of the present disclosure.

FIG. 19 is a flowchart illustrating an example of a flow of calibration processing according to the embodiment of the present disclosure.

FIG. 20 is a flowchart illustrating an example of a flow of the calibration processing according to the embodiment of the present disclosure.

FIG. 21 is a flowchart illustrating an example of a flow of imaging processing according to the embodiment of the present disclosure.

FIG. 22 is a hardware configuration diagram illustrating an example of a computer that implements functions of the information processing device.

### DESCRIPTION OF EMBODIMENTS

An embodiment of the present disclosure is explained in detail below with reference to the accompanying drawings. Note that, in the present specification and the drawings, components having substantially the same functional configurations are denoted by the same reference numerals and signs, whereby redundant explanation of the components is omitted.

In the present specification and the drawings, a plurality of components having substantially the same or similar functional configuration may be distinguished by adding different numerals after the same reference numerals. However, when it is unnecessary to particularly distinguish each of a plurality of components having substantially the same or similar functional configuration, only the same reference numerals are added. Similar components in different embodiments are sometimes distinguished by adding different alphabets or numbers after the same reference numerals. However, when it is unnecessary to particularly distinguish each of the similar components, only the same reference numerals are added.

In the present specification and the drawings, specific values are sometimes indicated for explanation. However, the values are examples, and other values may be applied.

One or a plurality of embodiments (including examples and modifications) explained below can be respectively independently implemented. On the other hand, at least a part of the plurality of embodiments explained below may be implemented in combination with at least a part of other embodiments as appropriate. These plurality of embodiments can include new characteristics different from one another. Therefore, these plurality of embodiments can contribute to solving objects or problems different from one another and can achieve effects different from one another.

### 1. Schematic Configuration Example of an Information Processing System

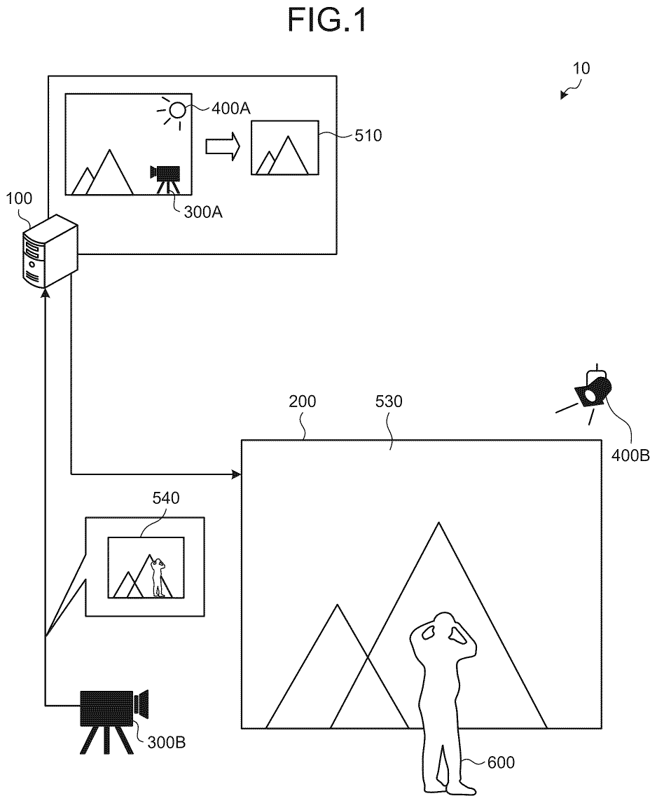

FIG. 1 is a diagram for explaining an overview of an information processing system 10 according to an embodiment of the present disclosure. The information processing system 10 includes an information processing device 100, a display device 200, an imaging device 300, and a light source 400.

The display device 200 is, for example, an LED (Light Emitting Diode) display (LED wall) having the size of an entire wall and can be disposed in a real space such as a studio. As illustrated in FIG. 1, in the information processing system 10 according to the embodiment of the present disclosure, a performer 600 performs a performance in front of the display device 200 that displays a video of a three-dimensional virtual space as a background and an imaging device 300B photographs the performance. Consequently, the information processing system 10 can acquire a video as if the performer 600 performed in the three-dimensional virtual space.

Here, in the embodiment of the present disclosure, the information processing device 100 generates a background image 510 (an example of a re-photographing image) to be displayed on the display device 200. In the example illustrated in FIG. 1, the information processing device 100 generates a background image 510 photographed by a virtual imaging device 300A under a virtual light source 400A in the three-dimensional virtual space.

The imaging device 300A is, for example, a device (for example, a virtual camera) that images a subject in the three-dimensional virtual space (for example, a CG space). The imaging device 300A is, for example, an RGB camera that photographs a background image 510 of an RGB value. Note that, here, the imaging device 300A is assumed to be a virtual RGB camera that images a subject in a three-dimensional virtual space but is not limited thereto. For example, the imaging device 300A may be an RGB camera that images a subject in the real space. For example, the background image 510 may be an image created using a photogrammetry technology or the like or may be a real image obtained by imaging a landscape, a person, or the like with the imaging device 300A. Furthermore, the real space in which the imaging device 300A performs photographing can be a real space in which the display device 200 is disposed, that is, a space different from the real space in which the imaging device 300B performs photographing.

The information processing device 100 converts the generated background image 510 into an image for display (a display image) on the display device 200 and displays the display image on the display device 200.

The imaging device 300B is disposed in the same real space as the real space where the display device 200 is disposed. The imaging device 300B acquires a captured image 540 by simultaneously photographing a display image displayed on the display device 200 and the performer 600. The imaging device 300B is, for example, an RGB camera that photographs the captured image 540 of an RGB value.

Note that, in the example illustrated in FIG. 1, the imaging device 300B photographs the captured image 540 under a light source 400B such as an LED. The imaging device 300B outputs the captured image 540 to the information processing device 100.

Note that, in FIG. 1, a case in which the display device 200 is an LEDwall on the entire wall surface is illustrated. However, the display device 200 is not limited thereto. For example, the display device 200 may include a plurality of LEDwalls. Alternatively, the display device 200 may be a device that displays the background image 510 on a wall surface and a ceiling (or a floor surface). Alternatively, the display device 200 may be a device having a predetermined size such as the same size as a person in the real space. That is, the background image 510 displayed by the display device 200 can include an image of an object such as a person in addition to an image of a background such as a landscape.

Here, the display device 200 is an LED display but is not limited thereto. For example, the display device 200 may be an LCD (Liquid Crystal Display) or an organic EL (Electroluminescence) display.

### 2. Problems of the Related Art

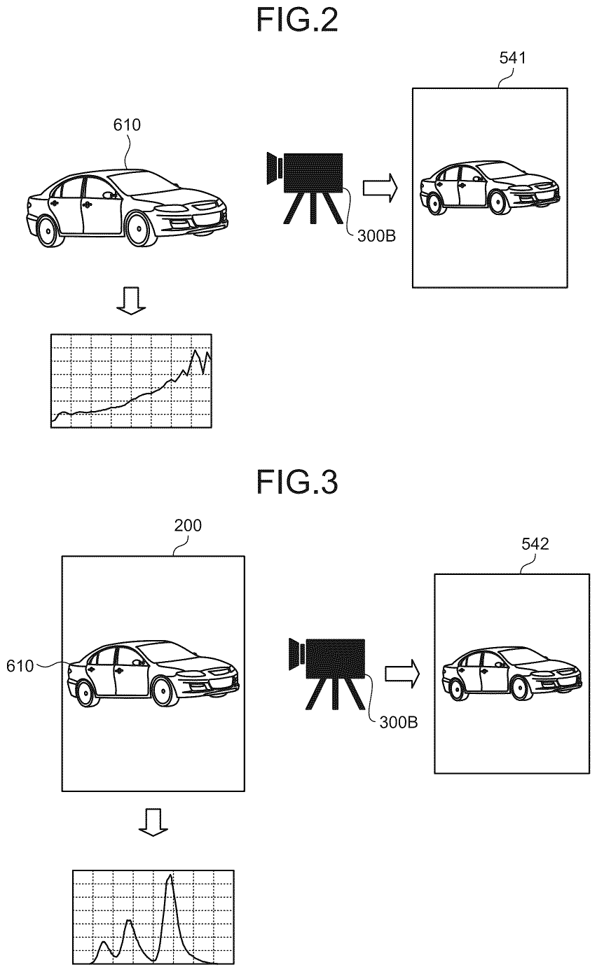

Here, in the information processing system 10, colors (RGB values) of a photographed image obtained by photographing a display image displayed on the display device 200 with the imaging device 300B and a photographed image obtained by photographing an object in the real space are sometimes different. This point is explained with reference to FIG. 2 and FIG. 3. Note that, in the following explanation, a photographed image obtained by photographing a display image displayed on the display device 200 with the imaging device 300B is also referred to as display photographed image. A photographed image obtained by photographing an object in the real space is also referred to as real object photographed image.

FIG. 2 is a diagram for explaining an example of the real object photographed image. As illustrated in FIG. 2, the imaging device 300B images an object 610 (an automobile in an example illustrated FIG. 2) disposed in the real space and generates a real object captured image 541.

Here, spectral characteristics of the object 610 is determined by spectral characteristics of a light source in the real space and the spectral reflectance of the object 610. As illustrated in a graph of FIG. 2, the distribution of the spectral characteristics of the object 610 disposed in the real space is, for example, a gentle distribution.

FIG. 3 is a diagram for explaining an example of a display photographed image. As illustrated in FIG. 3, the imaging device 300B images the object 610 displayed on the display device 200 disposed in the real space and generates a display captured image 542. Note that the object 610 displayed on the display device 200 is assumed to be the same object as the object 610 (see FIG. 2) disposed in the real space.

At this time, even though the imaging device 300B photographs the same object 610, the RGB values of the real object captured image 541 and the RGB values of the display captured image 542 are sometimes different values.

This is because the spectral characteristics of the object 610 disposed in the real space and the spectral characteristics of the object 610 displayed on the display device 200 are different.

Here, the display image displayed on the display device 200 is, for example, an image captured by the imaging device 300A. Therefore, the spectral characteristics of the object 610 displayed on the display device 200 are characteristics corresponding to the spectral characteristics of the display device 200. For example, as illustrated in a graph of FIG. 3, the distribution of the spectral characteristics of the object 610 displayed on the display device 200 is a distribution having peaks near wavelengths of R (Red), G (Green), and B (Blue).

As explained above, the spectral distribution of the object 610 disposed in the real space and the spectral distribution of the object 610 displayed on the display device 200 are different. Therefore, when the same object 610 is imaged by the imaging device 300B, the RGB values of the real object captured image 541 and the RGB values of the display captured image 542 are different values.

For example, it is assumed that the display device 200 is adjusted such that XYZ values of the object 610 and the display device 200 are the same. In this case, the RGB values of the real object captured image 541 and the display captured image 542 are not the same value, although the captured images are a condition equal color pair.

Here, the condition equal color pair means that, when colors of two objects are measured with a colorimeter, measurement results sometimes indicate the same color even if the spectral characteristics of the two objects are different. As explained above, the spectral characteristics of the object 610 in the real space and the spectral characteristics of the object 610 displayed on the display device 200 are different. Therefore, for example, by adjusting an xy color coordinate of the object 610 displayed on the display device 200, hues of the object 610 in the real space and the object 610 displayed on the display device 200 can be aligned when viewed from a human present in the real space.

However, the spectral characteristics of the imaging device 300B are different from the spectral characteristics of human eyes. Therefore, even if the hues of the object 610 in the real space and the object 610 displayed on the display device 200 are the same when viewed from the person present in the real space, hues of the real object captured image 541 and the display captured image 542 photographed by the imaging device 300B are different.

As explained above, when the display image displayed on the display device 200 is photographed again by the imaging device 300B, there is a problem in that the hue of the display captured image 542 obtained by photographing the display image and the hue of the real object captured image 541 obtained by imaging the object 610 in the real space are different.

Therefore, even if the display image and the object 610 in the real space are simultaneously photographed, the hue of the display image and the hue of the object 610 in the real space are different. It is likely that a realistic photographed image cannot be obtained.

### 3. Overview of Calibration

As explained above, by being processed in different paths, even the same value is sometimes a different value for each of the paths. In the example explained above, even for the same object 610, a value of an obtained image is sometimes different if a method of photographing the object 610 (a method (a path) of directly imaging the object 610) and a method (a path) of displaying the object 610 on the LEDwall 200 and imaging the object 610) is different.

Even in such a case, there is known a technique of performing calibration to obtain the same value by comparing values for each of the paths and calculating a correction coefficient.

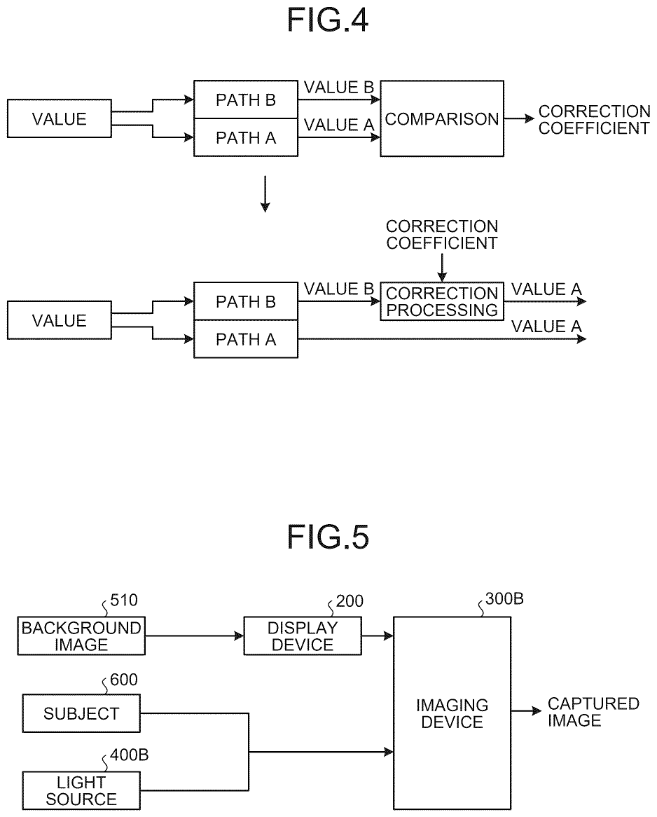

FIG. 4 is a diagram illustrating an example of an overview of calibration. In FIG. 4, it is assumed that the same value is converted into different values A and B by being respectively processed in different paths (a path A, and a path B).

In this case, as illustrated in an upper diagram of FIG. 4, a correction coefficient is calculated by comparing the different values A and B.

In an example of a lower diagram of FIG. 4, the value B is converted into the value A by performing correction processing using the correction coefficient on the value B at a later stage of the path B. Consequently, values that have passed through the different paths A and B are aligned with the same value A.

Note that, although the calibration in which the correction processing is performed at the later stage of the path B is explained here, the correction processing may not be performed at the later stage of the path B. For example, the correction processing may be performed at a later stage of the path A. Alternatively, the correction processing may be performed at a pre-stage of the path A or at a pre-stage the path B. As explained above, the correction processing can be performed at the pre-stage or the later stage of at least one of the path A and the path B. Alternatively, the correction processing may be executed in at least one of the path A and the path B, that is, as processing for at least one of the path A and the path B.

In addition, in the example illustrated in FIG. 4, if values input to both the path A and the path B at the time of calibration (at the time of correction coefficient calculation) are not the same value, an error is likely to be included in a calculated correction coefficient. Therefore, even if correction is performed using the correction coefficient, an error is also likely to be included in a value after the correction.

### 4. Example of Information Processing of the Information Processing System

An example of information processing in the information processing system 10 explained above is explained with reference to FIG. 5. FIG. 5 is a diagram illustrating an example of information processing according to the embodiment of the present disclosure.

As illustrated in FIG. 5, in the information processing system 10, a background image 510 is displayed on the display device 200. The light source 400B and the subject 600 disposed under an imaging environment and the background image 510 displayed on the display device 200 are respectively imaged by the imaging device 300B and a captured image is generated.

In the information processing system 10 according to the present embodiment, there are two paths including a background path on which the background image 510 is processed and a foreground path on which light from the subject 600 and the light source 400B is processed. The background path includes processing for causing the display device 200 to display the background image 510 and processing for the imaging device 300B to capture the background image 510 displayed on the display device 200. The foreground path includes processing in which subject 600 is imaged by the imaging device 300B under the light source 400B. Note that the background path may include processing for generating the background image 510.

As explained above, the captured image captured by the imaging device 300B includes values respectively processed in the background path and the foreground path. Therefore, even if values before being processed in the background path and the foreground path are the same value (here, for example, the same color or the same subject), a value (for example, a pixel value) acquired by the imaging device 300B by performing imaging is different for each of the paths.

Therefore, the information processing system 10 according to the present embodiment performs calibration by comparing outputs of the background path and the foreground path. Note that, in the following explanation, in order to simplify the explanation, it is assumed that the information processing device 100 of the information processing system 10 performs calibration, more specifically, calculation of a correction coefficient. However, a device that performs calibration is not limited to the information processing device 100.

For example, the calibration may be performed using an information processing function loaded on the display device 200 or an information processing function loaded on the imaging device 300B. Alternatively, a not-illustrated external device may perform calibration. Alternatively, calibration may be performed by a plurality of devices. In this case, a device that performs calibration among the display device 200, the imaging device 300B, and the external device functions as an information processing device.

### 4.1. Overview of Calibration According to Proposed Technology

The information processing device 100 according to the present embodiment acquires a first image obtained when a display image displayed on the display device 200 is captured by the imaging device 300B. The information processing device 100 acquires a second image obtained when imaging is performed by the imaging device 300B in an imaging environment (a photographing environment).

When the imaging device 300B captures, based on the first image and the second image, the background image 510 displayed on the display device 200 disposed in the imaging environment, the information processing device 100 calculates a correction coefficient used to display the background image 510 after correction on the display device 200.

The correction coefficient calculated by the information processing device 100 is applied to the background path, whereby calibration of the information processing system 10 is performed.

Consequently, when the same color is input, the information processing system 10 according to the present embodiment can further reduce the difference between a color (for example, a pixel value) obtained by being processed in the background path and a color (for example, a pixel value) obtained by being processed in the foreground path. Therefore, the information processing system 10 can acquire a captured image with higher reality.

### 4.2. First Calibration Example

First, a first calibration example is explained. In this example, the information processing device 100 calculates a correction coefficient by comparing the first image and the second image explained above.

### 4.2.1. Correction Coefficient Calculation Processing

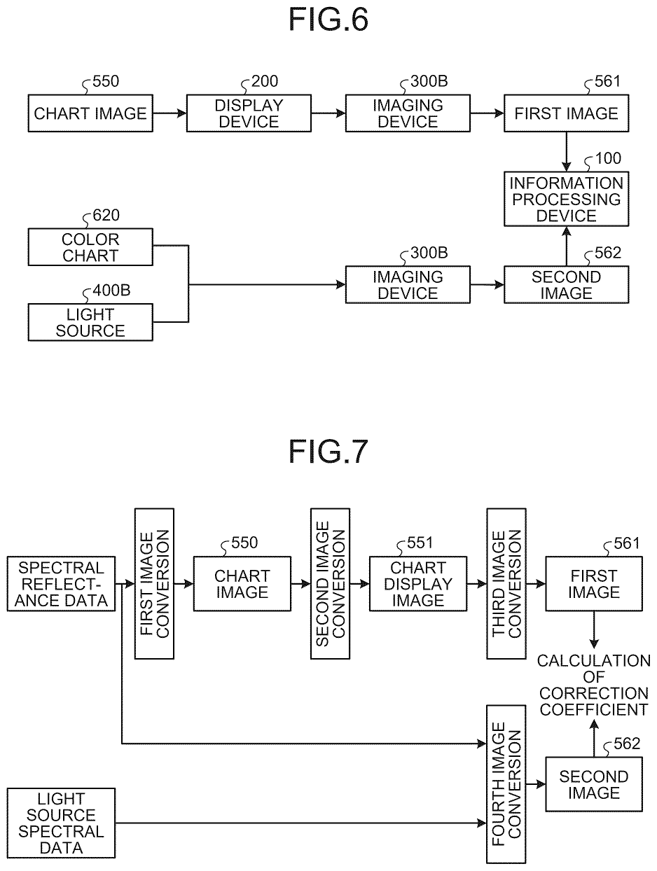

FIG. 6 is a diagram for explaining an example of correction coefficient calculation processing according to the embodiment of the present disclosure. In FIG. 6, the information processing system 10 generates a first image 561 and a second image 562. As explained above, the first image 561 and the second image 562 can be generated using an actual machine. The information processing device 100 acquires the generated first image 561 and the generated second image 562 and calculates a correction coefficient.

As illustrated in FIG. 6, a chart image 550 including at least one sample color is displayed on the display device 200. The imaging device 300B captures a chart image (hereinafter also described as chart display image 551) displayed on the display device 200, whereby the first image 561 is generated. The first image 561 is input to the information processing device 100.

A color chart 620 is imaged by the imaging device 300B under the light source 400B disposed in the imaging environment, whereby the second image 562 is generated. The second image 562 is input to the information processing device 100.

Here, it is assumed that the chart image 550 and the color chart 620 include the same sample color. For example, the chart image 550 is an RGB image obtained by imaging the color chart 620. At this time, the color chart 620 may be imaged in an environment different from the imaging environment and the chart image 550 may be generated.

Alternatively, the chart image 550 may be an RGB image generated based on spectral reflectance data of the color chart 620.

The imaging environment in the case of calculating the correction coefficient, that is, in the case of generating the first image 561 and the second image 562 is not necessarily the same as an environment in which imaging is actually performed after calibration (hereinafter also described as actual imaging environment). For example, the spectral characteristics of the light source 400B, the characteristics of the imaging device 300B, and the setting (for example, white balance) of the display device 200 only have to be the same as those of a light source, an imaging device, and a display device disposed in the actual imaging environment and places and the like may be different.

The information processing device 100 can directly acquire the first image 561 and the second image 562 from the imaging device 300B. Alternatively, the information processing device 100 can acquire the first image 561 and the second image 562 as image files from the imaging device 300B. In this case, the information processing device 100 may acquire the image files by direct communication with the imaging device 300B or may acquire the image files via a detachable storage medium such as a USB memory or an SD card.

The information processing device 100 calculates a correction coefficient based on the acquired first image 561 and the acquired second image 562. For example, the information processing device 100 compares pixel values of the same color respectively included in the first image 561 and the second image 562 and calculates a correction coefficient such that the difference between the pixel values becomes smaller. For example, the information processing device 100 calculates a correction coefficient using an existing technology such as the least squares method.

For example, the information processing device 100 calculates a correction coefficient based on the second image 562. That is, the information processing device 100 calculates a correction coefficient for correcting the background path. Alternatively, the information processing device 100 may calculate a correction coefficient based on the first image 561. That is, the information processing device 100 may calculate a correction coefficient for correcting the foreground path.

FIG. 7 is a diagram for explaining another example of the correction coefficient calculation processing according to the embodiment of the present disclosure. In FIG. 7, the information processing device 100 generates the first image 561 and the second image 562. In this way, the first image 561 and the second image 562 may be calculated on a desk. The information processing device 100 generates the first image 561 and the second image 562 and calculates a correction coefficient based on the generated first image 561 and the generated second image 562.

As illustrated in FIG. 7, the information processing device 100 generates the chart image 550 by performing first image conversion using the spectral reflectance data. Here, for example, it is assumed that the information processing device 100 performs the first image conversion using the spectral reflectance data of the color chart 620 illustrated in FIG. 6 to generate the chart image 550.

The information processing device 100 performs second image conversion based on the display characteristics of the display device 200 on the chart image 550 to generate the chart display image 551. The display characteristics are, for example, characteristics in which, when an RGB image is input to the display device 200, the display device 200 outputs the RGB image as light. Examples of the display characteristics include white balance. The chart display image 551 is an image obtained by generating, with a simulation, an image obtained when the chart image 550 is displayed on the display device 200.

The information processing device 100 performs third image conversion based on the imaging characteristics of the imaging device 300B on the chart display image 551 to generate the first image 561. The imaging characteristics are, for example, characteristics concerning an RGB image output by the imaging device 300B when light is input to the imaging device 300B. Examples of the imaging characteristics include a spectral sensitivity characteristic of the imaging device 300B and white balance. The first image 561 is an image obtained by generating, with a simulation, an image obtained when the chart display image 551 is captured by the imaging device 300B.

Note that, here, the information processing device 100 performs the first to third image conversions to generate the first image 561. However, the information processing device 100 may generate the first image 561 by performing image conversion once.

For example, the first to third image conversions may be combined into one image conversion. The information processing device 100 may generate the first image 561 by performing the image conversion on the spectral reflectance data.

As explained above, the number of times of the image conversion performed by the information processing device 100 to generate the first image 561 is not limited to three and may be two or less or may be four or more.

As illustrated in FIG. 7, the information processing device 100 performs fourth image conversion using spectral reflectance data and light source spectral data and the imaging characteristics of the imaging device 300B and generates the second image 562. For example, the information processing device 100 performs the fourth image conversion by generating, as the second image 562, an image in the case in which the spectral reflectance data and the light source spectral data multiplied together is imaged by the imaging device 300B.

The spectral reflectance data used by the information processing device 100 in the fourth image conversion is assumed to be the same as the spectral reflectance data used for generating the first image 561. The light source spectral data is the same as the spectral characteristic data of the light source 400B disposed in the actual imaging environment. As the light source spectral data, light source spectral data calculated in advance from the type of the light source 400B or the like may be used or spectral data of the light source 400B may be measured using a spectrometer or the like.

The information processing device 100 that has generated the first image 561 and the second image 562 compares these images and calculates a correction coefficient. A method of calculating the correction coefficient is the same as that in the case illustrated FIG. 6.

Note that, although the method of generating the first image 561 and the second image 562 using the actual machine and the method of generating the first image 561 and the second image 562 on a desk are explained here, a method of generating the first image 561 and the second image 562 is not limited thereto. A part of the processing explained above may be performed by an actual machine and the remaining processing may be performed on a desk, for example, the first image 561 may be generated on a desk (for example, by the information processing device 100), the second image 562 may be generated by an actual machine.

### 4.2.2. Application of the Correction Coefficient

The information processing system 10 applies the correction coefficient calculated by the information processing device 100 to at least one of the background path and the foreground path to execute calibration. An example of a method of applying the correction coefficient by the information processing system 10 is explained below. Note that, unless particularly described otherwise, the explanation is made assuming that the information processing device 100 applies the correction coefficient.

### First Application Example

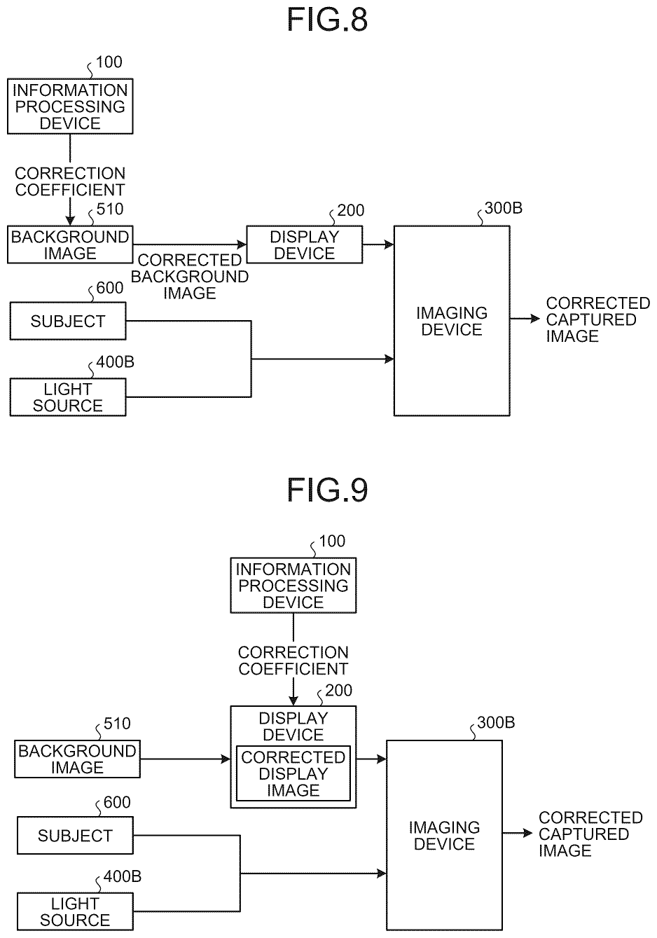

FIG. 8 is a diagram for explaining a first application example of the correction coefficient according to the embodiment of the present disclosure. FIG. 8 illustrates a case in which the information processing device 100 applies the correction coefficient to the background image 510.

As illustrated in FIG. 8, the information processing device 100 applies the correction coefficient to the background image 510 to generate a corrected background image. The information processing device 100 inputs the generated corrected background image to the display device 200. The display device 200 displays the corrected background image. The imaging device 300B images the corrected background image displayed on the display device 200 and the subject 600 and generates a corrected captured image.

Here, it is assumed that, when the background image 510 is corrected in the correction coefficient calculation processing explained above, the information processing device 100 calculates a correction coefficient for reducing the difference between a color in the case in which the corrected background image is re-photographed and a color of the subject 600.

For example, the information processing device 100 calculates a correction coefficient for adding the influence of the light source 400B and canceling the influence of the display device 200. The information processing device 100 can further reduce the color difference between the first image 561 and the second image 562 by correcting the background image 510 using the correction coefficient. Consequently, the imaging device 300B can capture an image with higher reality.

### Second Application Example

FIG. 9 is a diagram for explaining a second application example of the correction coefficient according to the embodiment of the present disclosure. FIG. 9 illustrates a case in which the information processing device 100 applies the correction coefficient to the display device 200.

As illustrated in FIG. 9, the information processing device 100 applies the correction coefficient to the display device 200 by inputting the correction coefficient to the display device 200. The display device 200 performs processing (for example, correction processing) corresponding to the correction coefficient on the background image 510 and displays the background image 510. In the following explanation, an image displayed by the display device 200 applying the correction coefficient is also described as corrected display image.

The imaging device 300B images the corrected display background image and the subject 600 to generate a corrected captured image.

Here, it is assumed that, when the background image 510 is corrected in the correction coefficient calculation processing explained above, the information processing device 100 calculates a correction coefficient for reducing the difference between a color in the case in which the corrected background image is re-photographed and a color of the subject 600.

For example, the information processing device 100 calculates a correction coefficient for adding the influence of the light source 400B and canceling the influence of the display device 200. The information processing device 100 can further reduce the color difference between the first image 561 and the second image 562 by correcting the background image 510 using the correction coefficient. Consequently, the imaging device 300B can capture an image with higher reality.

### Third Application Example

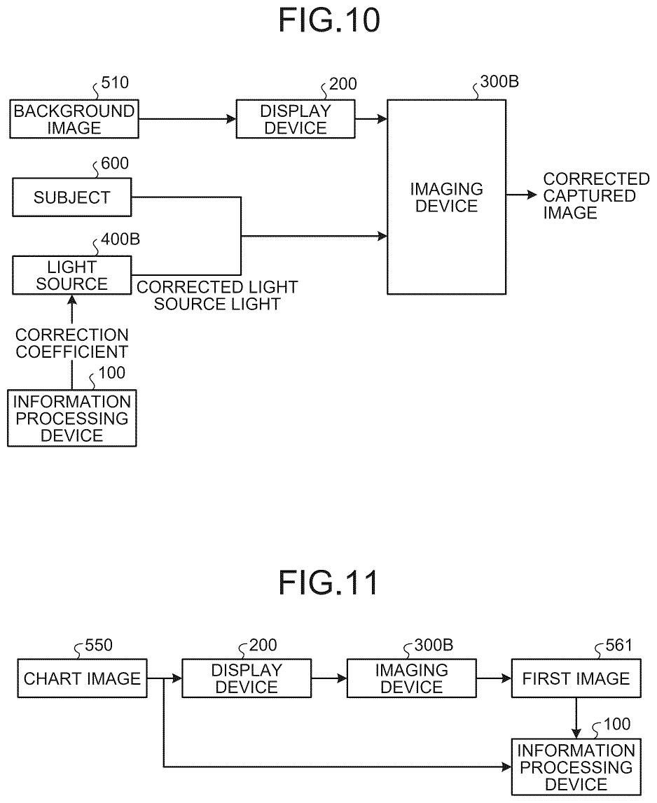

FIG. 10 is a diagram for explaining a third application example of the correction coefficient according to the embodiment of the present disclosure. FIG. 10 illustrates a case in which the information processing device 100 applies the correction coefficient to the light source 400B.

As illustrated in FIG. 10, the information processing device 100 applies the correction coefficient to the light source 400B by inputting the correction coefficient to the light source 400B. The light source 400B corrects characteristics according to the correction coefficient. For example, the light source 400B corrects, according to the correction coefficient, the characteristics by changing a color of light to be emitted and emits corrected light source light.

For example, the information processing device 100 calculates a correction coefficient for cancelling the influence of the light source 400B and adding the influence of the display device 200. The information processing device 100 can reduce the influence of the light source 400B and the influence of the display device 200 by applying this correction coefficient to the light source 400B. Consequently, the imaging device 300B can capture an image with higher reality.

Note that correction that the light source 400B can perform is limited in content and the like thereof. Therefore, the light source 400B performs, based on the correction coefficient, for example, correction that can further reduce the influence of the light source 400B and the influence of the display device 200.

As explained above, the correction coefficient includes the influence of the display device 200 and the influence of the light source 400B. Therefore, the information processing device 100 may separate the correction coefficient into a first correction coefficient including the influence of the display device 200 and a second correction coefficient including the influence of the light source 400B and apply the first correction coefficient and the second correction coefficient to the respective paths.

For example, the information processing device 100 calculates the first correction coefficient for canceling the influence of the display device 200 and applies the first correction coefficient to the background path. For example, the information processing device 100 calculates the second correction coefficient for canceling the influence of the light source 400B and applies the second correction coefficient to the foreground path.

For example, the information processing device 100 calculates the first correction coefficient for adding the influence of the display device 200 and applies the first correction coefficient to the foreground path. For example, the information processing device 100 calculates the second correction coefficient for adding the influence of the light source 400B and applies the second correction coefficient to the background path.

The information processing device 100 can disperse and reduce the influence of the display device 200 and the influence of the light source 400B by separating the correction coefficient into the first correction coefficient and the second correction coefficient and applying the correction coefficient to the information processing system 10 as explained above.

The information processing device 100 can change a balance between the influence of the display device 200 and the influence of the light source 400B included in the first correction coefficient and the second correction coefficient. Consequently, the information processing device 100 can adjust a calibration reference to a foreground path reference, a background path reference, or an intermediate reference between the foreground path and the background path.

### 4.3. Second Calibration Example

Next, a second calibration example is explained. In this example, the information processing device 100 calculates the first correction coefficient and the second correction coefficient for each of the first image 561 and the second image 562 explained above.

### 4.3.1. Correction Coefficient Calculation Processing

FIG. 11 is a diagram for explaining an example of first correction coefficient calculation processing according to the embodiment of the present disclosure. In FIG. 11, the information processing system 10 generates the first image 561. That is, here, it is assumed that the first image 561 is generated using an actual machine.

Note that the first image 561 may be generated on a desk (for example, in the information processing device 100). Since a method of generating the first image 561 on an actual machine and a method of generating the first image 561 on a desk are the same as the methods illustrated in FIG. 6 and FIG. 7, explanation of the methods is omitted.

The information processing device 100 compares the chart image 550 (an example of a display image) and the first image 561 and calculates a first correction coefficient (an example of a first coefficient). The first correction coefficient includes the influence of the display device 200 and the influence of the imaging device 300B (the influence of the spectral characteristics of the imaging device 300B on the spectral characteristics of the display device 200). As explained above, the information processing device 100 calculates the first correction coefficient based on the chart image 550 and the first image 561.

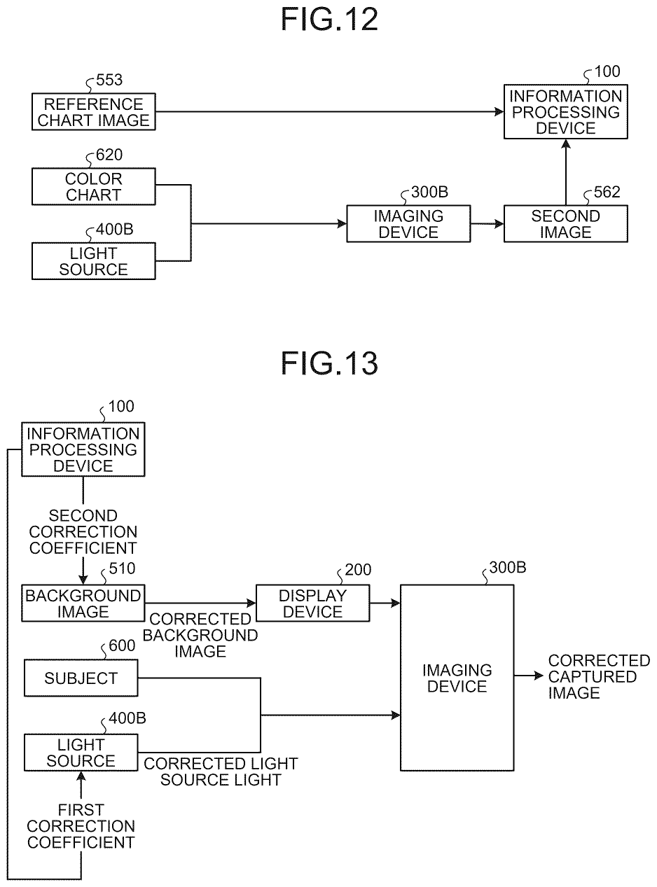

FIG. 12 is a diagram for explaining an example of second correction coefficient calculation processing according to the embodiment of the present disclosure. In FIG. 12, the information processing system 10 generates the second image 562. That is, here, it is assumed that the second image 562 is generated using an actual machine.

Note that the second image 562 may be generated on a desk (for example, in the information processing device 100). Since a method of generating the second image 562 on an actual machine and a method of generating the second image 562 on a desk are the same as the methods illustrated in FIG. 6 and FIG. 7, explanation of the methods is omitted.

The information processing device 100 compares the reference chart image 553 (an example of a reference image) and the second image 562 and calculates a second correction coefficient (an example of a second coefficient). The second correction coefficient includes the influence of the light source 400B. As explained above, the information processing device 100 calculates the second correction coefficient based on the reference chart image 552 and the second image 562.

Here, the reference chart image 553 is an image obtained when the color chart 620 is photographed, for example, under a reference light source. The reference light source may be, for example, a light source 400A (see FIG. 1) in an environment in which the background image 510 is captured or may be a standard light source such as a D65 light source.

### 4.3.2. Application of the Correction Coefficient

For example, the information processing device 100 calculates one correction coefficient from the calculated first correction coefficient and second correction coefficient. The information processing device 100 can perform calibration by applying the calculated correction coefficient to at least one of the background path and the foreground path. An example in which the correction coefficient is applied to one of the background path and the foreground path is the same as the examples illustrated in FIG. 8 to FIG. 10. Therefore, explanation of the example is omitted.

Alternatively, the information processing device 100 may perform calibration by applying the calculated first correction coefficient and the calculated second correction coefficient respectively to the background path and the foreground path.

FIG. 13 is a diagram for explaining an application example of the first and second correction coefficients according to the embodiment of the present disclosure.

As explained above, the first correction coefficient includes the influence of the display device 200. The second correction coefficient includes the influence of the light source 400B.

Therefore, for example, when calculating the first correction coefficient for adding the influence of the display device 200, the information processing device 100 applies the first correction coefficient to the light source 400B. The information processing device 100 can apply the first correction coefficient to the light source 400B in in the same manner as the method illustrated in FIG. 10.

For example, when calculating the second correction coefficient for adding the influence of the light source 400B, the information processing device 100 applies the second correction coefficient to the background image 510. The information processing device 100 can apply the second correction coefficient to the background image 510 in the same manner as the method illustrated in FIG. 8.

Alternatively, the information processing device 100 may apply, to the display device 200, the second correction coefficient for adding the influence of the light source 400B. The information processing device 100 can apply the second correction coefficient to the display device 200 in the same manner as the method illustrated in FIG. 9.

Note that, here, the information processing device 100 applies the first correction coefficient to the background path and applies the second correction coefficient to the foreground path. However, the information processing device 100 may apply the first correction coefficient to the foreground path and apply the second correction coefficient to the background path.

In this case, the information processing device 100 calculates the first correction coefficient for canceling the influence of the display device 200 and applies the first correction coefficient to at least one of the background image 510 and the display device 200. The information processing device 100 calculates the second correction coefficient for canceling the influence of the light source 400B and applies the second correction coefficient to the light source 400B.

As explained above, the information processing device 100 can perform calibration of the information processing system 10 by calculating the first correction coefficient and the second correction coefficient respectively for the foreground path and the background path. Consequently, the imaging device 300B can capture an image with higher reality.

### 4.4. Presentation of Calibration Information

The information processing device 100 can present information concerning calibration (hereinafter also described as calibration information) to a user (for example, a person who performs imaging using the imaging device 300B) or the like.

The information processing device 100 can present the calibration information to the user by displaying the calibration information on a display unit (not illustrated) included in the information processing device 100. Alternatively, the information processing device 100 may display the calibration information on the display device 200 of the information processing system 10 or may display the calibration information using a display function of the information processing system 10 such as a display unit (not illustrated) of the imaging device 300B. As explained above, when the information processing device 100 displays the calibration information using the display function of another device, the information processing device 100 may not have the display function. By transferring the calibration information to an external terminal (not illustrated) that is an external device such as a smartphone or a tablet PC by using wired communication or wireless communication, the information processing device 100 may display the calibration information on a display unit of the external device.

For example, the information processing device 100 can present images before and after the calibration to the user as the calibration information. For example, the information processing device 100 presents, to the user, a captured image before the application of the correction coefficient and a corrected captured image after the application of the correction coefficient. In this case, the information processing device 100 may present the captured image and the corrected captured image side by side to the user or may individually present the captured image and the corrected captured image to the user.

Alternatively, the information processing device 100 may present, for example, the first image 561 and the second image 562 to the user as the calibration information.

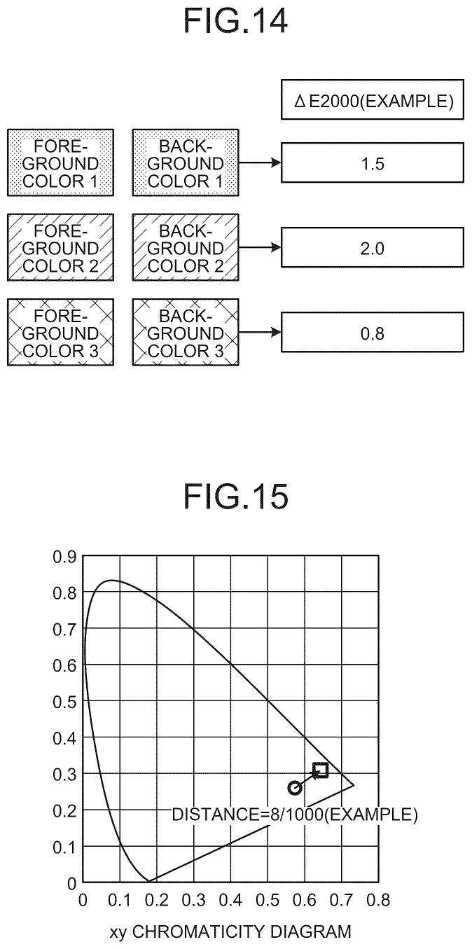

FIG. 14 is a diagram illustrating an example of calibration information presented by the information processing device 100 according to the embodiment of the present disclosure.

As illustrated in FIG. 14, the information processing device 100 displays the first image 561 and the second image 562 side by side for each of sample colors included in the images. For example, the information processing device 100 displays sample colors (in FIG. 14, foreground colors #1 to #3) included in the second image 562 and sample colors (in FIG. 14, background colors #1 to #3) included in the first image 561 side by side for each of the sample colors.

Note that the foreground colors and the background colors having the same numbers are colors obtained by, respectively in the foreground path and the background path, processing sample colors having the same spectral reflectance.

The information processing device 100 presents the first image 561 and the second image 562 to the user for each of the sample colors as explained above. Consequently, the user can check a difference in color for each of the sample colors.

As illustrated in FIG. 14, in addition to (or instead of) the first image 561 and the second image 562, the information processing device 100 may present information concerning a color difference between the first image 561 and the second image 562 (an example of color difference information) to the user. In FIG. 14, the information processing device 100 presents a color difference value calculated using a color difference calculation method such as ΔE 2000 to the user for each of the sample colors as information concerning a color difference.

The information processing device 100 presents the information concerning the color difference to the user as explained above. Consequently, the user can confirm the color difference between the first image 561 and the second image 562 based on the information concerning the color difference.

FIG. 15 is a diagram illustrating another example of the calibration information presented by the information processing device 100 according to the embodiment of the present disclosure. In FIG. 15, the information processing device 100 illustrates the color difference between the first image 561 and the second image 562 on an xy chromaticity diagram.

For example, the information processing device 100 maps the sample colors included in the first image 561 and the second image 562 on the xy chromaticity diagram and presents the sample colors to the user. In the example illustrated in FIG. 15, the information processing device 100 maps a sample color of the first image 561 to a position indicated by a circle and maps a sample color of the second image 562 to a position indicated by a square.

As illustrated in FIG. 15, the information processing device 100 can present the color difference of the sample colors included in the first image 561 and the second image 562 as a Euclidean distance on the xy chromaticity diagram.

The information processing device 100 presents the calibration information to the user using the xy chromaticity diagram as explained above. Consequently, the user can more easily check the color difference between the first image 561 and the second image 562.

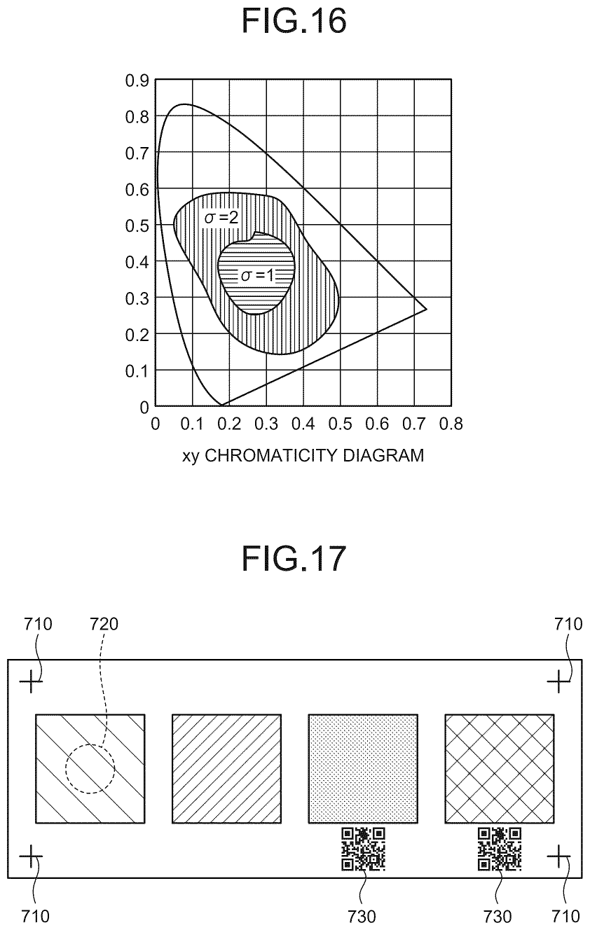

FIG. 16 is a diagram illustrating another example of the calibration information presented by the information processing device 100 according to the embodiment of the present disclosure.

The number of sample colors included in the first image 561 and the second image 562 may be a large number, for example, several thousand. As explained above, when a large number of sample colors are included in the first image 561 and the second image 562, the information processing device 100 can calculate at least one of values such as an average value, a median value, a standard deviation, and a worst value of the color difference based on the color difference for each of the large number of sample colors.

In FIG. 16, the information processing device 100 illustrates distribution information of the calculated standard deviation on an xy chromaticity diagram. In this way, the information processing device 100 can present statistical information of the color difference to the user as calibration information.

The information processing device 100 presents the statistical information of the color difference to the user as explained above. Consequently, the user can statistically check the color difference between the first image 561 and the second image 562.

Note that, in FIG. 15 and FIG. 16, as an example, the color difference between the first image 561 and the second image 562 is illustrated on the xy chromaticity diagram. However, the color difference may be represented by a chromaticity expression other than that on the xy chromaticity diagram.

Note that, in FIG. 14 to FIG. 16, the information processing device 100 presents the comparison result between the first image 561 and the second image 562 to the user as the calibration information. However, information presented by the information processing device 100 is not limited thereto.

For example, the information processing device 100 may present a comparison result between the first image 561 and a second image after correction (hereinafter also described as corrected second image) obtained by applying the correction coefficient to the foreground path to the user as the calibration information. The corrected second image is an image obtained when the correction coefficient is applied to the light source 400B and the color chart is imaged by the imaging device 300B.

Alternatively, the information processing device 100 may present a comparison result between a first image after correction (hereinafter also described as corrected first image) obtained by applying the correction coefficient to the background path and the second image 562 to the user as the calibration information. The corrected first image is an image obtained when the correction coefficient is applied to the chart image 550 or the display device 200 and a corrected chart image displayed on the display device 200 is captured by the imaging device 300B.

Information (for example, the first image 561 and the second image 562) used by the information processing device 100 to generate simulation information may be information generated on a desk or information acquired using an actual machine.

For example, the information processing device 100 may generate the first image 561 by itself or may acquire the first image from the imaging device 300B. Similarly, the information processing device 100 may generate the corrected first image by itself or may acquire the corrected first image from the imaging device 300B. The same applies to the second image 562 and the corrected second image.

### 4.5. Automatic Recognition of the Color Chart

As explained above, the information processing device 100 can acquire the second image 562 obtained by imaging the color chart with the imaging device 300B. For example, the information processing device 100 compares the sample color included in the second image 562 with the sample color included in the first image 561 to calculate the correction coefficient. At this time, for example, the information processing device 100 may automatically recognize the color chart using color chart information.

FIG. 17 is a diagram illustrating an example of the color chart according to the embodiment of the present disclosure. As illustrated in FIG. 17, the color chart includes at least one (four in the example illustrated in FIG. 17) marker 710 as the color chart information. For example, the information processing device 100 detects the shape of the color chart and the position of a sample color (a color mark) by detecting the marker 710 included in the second image 562.

Note that the shape, the color, and the number of markers 710 illustrated in FIG. 17 are examples and are not limited to the example illustrated in FIG. 17. The marker 710 only has to able to be detected by the information processing device 100 and the shape and the like of the marker 710 are optional. It is assumed that the information processing device 100 has acquired information concerning the marker 710 in advance. Alternatively, the information processing device 100 may have acquired information concerning the shape of the color chart in advance as the color chart information and detect the shape of the color chart from the second image 562.

The information processing device 100 having recognized the color chart detects a color value of the sample color by calculating an average value of a center region (for example, a region 720 of FIG. 17) of the sample color. For example, the information processing device 100 can calculate the average value of the center region for all sample colors included in the color chart.

The information processing device 100 detects the average value of the predetermined region as the sample color as explained above. Consequently, an error due to imaging can be reduced and the correction coefficient can be more accurately calculated.

The color chart can include sample color information concerning the sample color other than the marker 710. In the example illustrated in FIG. 17, the color chart has a two-dimensional barcode 730 including sample color information. The sample color information indicated by the two-dimensional barcode includes, for example, spectral reflectance of the sample color.

The information processing device 100 acquires the sample color information by reading the two-dimensional barcode. For example, the information processing device 100 calculates a correction coefficient using the sample color information.

Note that, here, the information processing device 100 acquires the sample color and the sample color information from the second image 562 using the marker 710 and the like. However, the information processing device 100 may acquire the sample color and the sample color information from the first image 561 in the same manner. In this case, the chart image 550 includes the marker 710 and the sample color information (for example, the two-dimensional barcode).

Here, a case in which the sample color information is included in the two-dimensional barcode is described. However, the sample color information may be information other than the two-dimensional barcode. For example, the sample color information may be information displayed as a character string or a number.

### 5. Configuration Example of the Information Processing Device

Next, a configuration example of the information processing device 100 is explained.

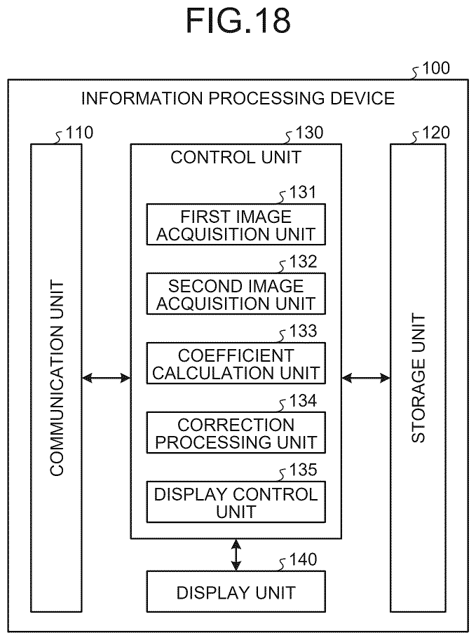

FIG. 18 is a block diagram illustrating a configuration example of the information processing device 100 according to the embodiment of the present disclosure. As illustrated in FIG. 18, the information processing device 100 includes a communication unit 110, a storage unit 120, a control unit 130, and a display unit 140.

### Communication Unit 110

The communication unit 110 is a communication interface that communicates with an external device via a network by wire or radio. The communication unit 110 is implemented by, for example, an NIC (Network Interface Card).

### Storage Unit 120

The storage unit 120 is a data readable/writable storage device such as a DRAM, an SRAM, a flash memory, or a hard disk. The storage unit 120 functions as storage means of the information processing device 100.

### Display Unit 140

The display unit 140 is, for example, a panel type display device such as a liquid crystal panel or an organic EL (Electro Luminescence) panel and displays, for example, the calibration information explained above according to control of the control unit 130. The display unit 140 functions as display means of the information processing device 100.

### Control Unit 130

The control unit 130 controls the units of the information processing device 100. The control unit 130 is realized by, for example, a program stored inside the information processing device 100 being executed by a CPU (Central Processing Unit), an MPU (Micro Processing Unit), a GPU (Graphics Processing Unit), or the like using a RAM (Random Access Memory) or the like as a work area. The control unit 130 is implemented by an integrated circuit such as an ASIC (Application Specific Integrated Circuit) or an FPGA (Field Programmable Gate Array).

The control unit 130 includes a first image acquisition unit 131, a second image acquisition unit 132, a coefficient calculation unit 133, a correction processing unit 134, and a display control unit 135. Blocks (the first image acquisition unit 131 to the display control unit 135) configuring the control unit 130 are respectively functional blocks indicating functions of the control unit 130. These functional blocks may be software blocks or may be hardware blocks. For example, each of the functional blocks explained above may be one software module implemented by software (including a micro program) or may be one circuit block on a semiconductor chip (die). Naturally, each of the functional blocks may be one processor or one integrated circuit. The control unit 130 may be configured in functional units different from the functional blocks explained above. A configuration method for the functional blocks is optional.

Note that the control unit 130 may be configured in functional units different from the functional blocks explained above. Another device may perform a part or all of the operations of the blocks (the first image acquisition unit 131 to the display control unit 135) configuring the control unit 130. For example, a control device realized by cloud computing may perform a part or all of the operations of the blocks configuring the control unit 130.

### First Image Acquisition Unit 131

The first image acquisition unit 131 acquires the first image 561 obtained when the chart display image 551 (an example of a display image) displayed on the display device 200 is captured by the imaging device 300B. The first image acquisition unit 131 acquires first image 561 captured by the imaging device 300B from the imaging device 300B. Alternatively, the first image acquisition unit 131 may acquire the first image 561 by generating the first image 561 from spectral reflectance data with image conversion processing.

The first image acquisition unit 131 outputs the acquired first image 561 to the coefficient calculation unit 133.

### Second Image Acquisition Unit 132

The second image acquisition unit 132 acquires the second image 562 obtained when a color chart is imaged by the imaging device 300B in an imaging environment (for example, under the light source 400B). The second image acquisition unit 132 acquires the second image 562 captured by the imaging device 300B from the imaging device 300B. Alternatively, the second image acquisition unit 132 may acquire the second image 562 by generating the second image 562 with image conversion processing from spectral reflectance data and spectral data of the light source 400B.

The second image acquisition unit 132 outputs the acquired second image 562 to the coefficient calculation unit 133.

### Coefficient Calculation Unit 133

Coefficient calculation unit 133 calculates a correction coefficient based on the first image 561 and the second image 562. The correction coefficient is used to display the corrected display image when the background image 510 displayed on the display device 200 disposed in an imaging environment is captured by the imaging device 300B. Alternatively, the correction coefficient can be used to correct the light source 400B.

The coefficient calculation unit 133 outputs the calculated correction coefficient to the correction processing unit 134.

### Correction Processing Unit 134

The correction processing unit 134 applies the correction coefficient to at least one of the foreground path and the background path of the information processing system 10. For example, the correction processing unit 134 applies the correction coefficient to the background path by performing correction processing on the background image 510 using the correction coefficient and generating a corrected background image. The correction processing unit 134 performs the correction processing using, for example, matrix operation or a 1D/3D LUT (Lookup Table).

Alternatively, the correction processing unit 134 can apply the correction coefficient to the background path by outputting the correction coefficient to the display device 200. In this case, for example, the display device 200 displays the corrected display image obtained by correcting the background image 510 with the correction coefficient.

The correction processing unit 134 can apply the correction coefficient to the foreground path by outputting the correction coefficient to the light source 400B. In this case, for example, the light source 400B emits irradiation light corrected according to the correction coefficient.

### Display Control Unit 135

The display control unit 135 causes the display unit 140 to display various kinds of information. For example, the display control unit 135 generates the calibration information explained above and causes the display unit 140 to display the calibration information.

Note that, here, the display control unit 135 causes the display unit 140 included in the information processing device 100 to display the calibration information. However, the display control unit 135 may cause a device other than the display unit 140 to display the calibration information. For example, the display control unit 135 may cause the display device 200 to display the calibration information. In this case, the display control unit 135 outputs the calibration information to the display device 200.

### 6. Processing Example

A processing example implemented by the information processing system 10 according to the embodiment of the present disclosure is explained below. In the information processing system 10, calibration processing for executing the calibration explained above and imaging processing for performing imaging to which a correction coefficient is applied in an actual imaging environment are performed.

### 6.1. Calibration Processing Example

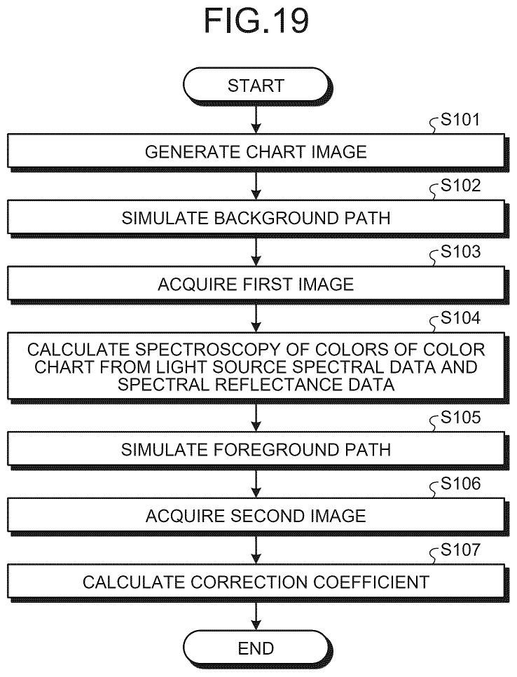

FIG. 19 is a flowchart illustrating an example of a flow of calibration processing according to the embodiment of the present disclosure. The calibration processing illustrated in FIG. 19 is executed by the information processing device 100. That is, the calibration processing illustrated in FIG. 19 is processing on a desk.

As illustrated in FIG. 19, the information processing device 100 generates the chart image 550 (Step S101). For example, the information processing device 100 generates the chart image 550 from spectral reflectance data. Note that the information processing device 100 may determine a conversion coefficient for conversion from the spectral reflectance data to the chart image 550 according to a color gamut of a production environment of the chart image 550.

Subsequently, the information processing device 100 simulates the background path (Step S102) and acquires the first image 561 (Step S103).

It is assumed that the information processing device 100 has acquired, in advance, with measurement or the like, characteristics of the display device 200, more specifically, conversion characteristics with which the display device 200 converts an input RGB image into output light. For example, the information processing device 100 may acquire the characteristics of the display device 200 from the display device 200 using wired communication or wireless communication or may acquire the characteristics of the display device 200 from the outside via the Internet.

It is assumed that the information processing device 100 has acquired, in advance, with measurement or the like, characteristics of the imaging device 300B, more specifically, conversion characteristics with which the imaging device 300B converts light input by the imaging device 300B into an RGB image. For example, the information processing device 100 may acquire the characteristics of the imaging device 300B from the imaging device 300B by using wired communication or wireless communication or may acquire the characteristics of the imaging device 300B from the outside via the Internet.

The information processing device 100 performs simulation of the background path using the characteristics of the display device 200 and the characteristics of the imaging device 300B and acquires the first image 561.

As illustrated in FIG. 19, the information processing device 100 calculates spectroscopy of colors of the color chart from the spectral data and the spectral reflectance data of the light source 400B (Step S104). Note that it is assumed that the information processing device 100 has acquired, in advance, spectral data of the light source 400B measured by a spectrometer or the like. For example, the information processing device 100 may acquire spectral data of the light source 400B from the light source 400B by using wired communication or wireless communication or may acquire spectral data of the light source 400B from the outside via the Internet.

Subsequently, the information processing device 100 simulates the foreground path (Step S105) and acquires the second image 562 (Step S106).

The information processing device 100 performs a simulation of the foreground path using the characteristics of the imaging device 300B explained above and acquires the second image 562.

The information processing device 100 calculates a correction coefficient using the first image 561 and the second image 562 (Step S107). The information processing device 100 calculates the correction coefficient using, for example, the least squares method.

Note that the processing in Step S101 to Step S103 and the processing in Step S104 to Step S106 may be executed by changing order or may be performed in parallel.

Here, a case in which the information processing device 100 generates the first image 561 and the second image 562 is explained. However, the information processing device 100 may acquire the first image 561 and the second image 562 from the imaging device 300B.

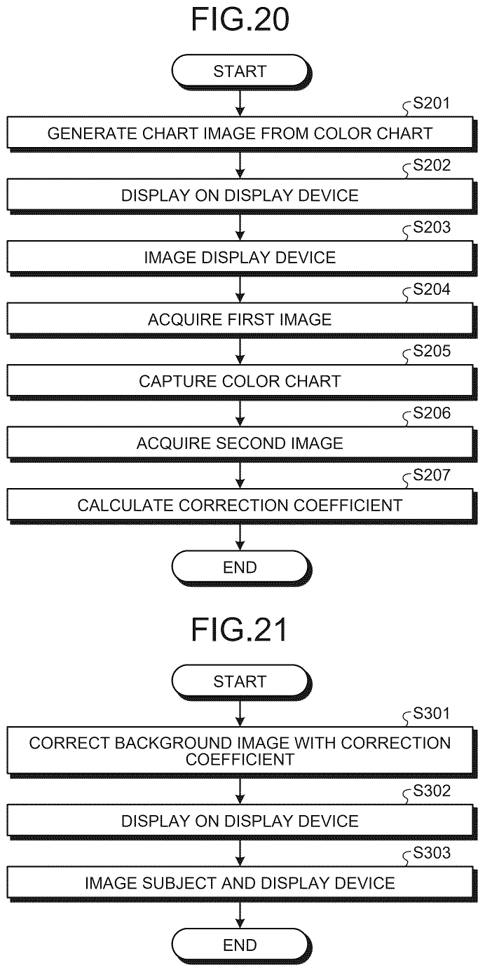

FIG. 20 is a flowchart illustrating an example of a flow of calibration processing according to the embodiment of the present disclosure. The calibration processing illustrated in FIG. 20 is executed by the devices of the information processing system 10. That is, the calibration processing illustrated in FIG. 20 is processing performed using an actual machine. Note that the same processing as the processing in FIG. 19 is denoted by the same reference signs and explanation of the processing is omitted.

As illustrated in FIG. 20, the information processing device 100 of the information processing system 10 generates the chart image 550 from the color chart (Step S201). For example, the information processing device 100 acquires the spectral reflectance data of the color chart and generates the chart image 550 based on the spectral reflectance data. The spectral reflectance data is, for example, data obtained by measuring spectral reflectance of an actual color chart.

Subsequently, the information processing device 100 inputs the chart image 550 to the display device 200 to cause the display device 200 to display the chart image 550 (Step S202). The imaging device 300B of the information processing system 10 images the display device 200 that has displayed the chart image 550 (Step S203). The information processing device 100 acquires the first image 561 from the imaging device 300B (Step S204).

The imaging device 300B captures an actual color chart placed in an imaging environment (for example, under the light source 400B) (Step S205). The information processing device 100 acquires the second image 562 from the imaging device 300B (Step S206). The information processing device 100 calculates a correction coefficient using the first image 561 and the second image 562 (Step S207). The information processing device 100 calculates the correction coefficient using, for example, the least squares method.

Note that the processing in Step S201 to Step S204 and the processing in Step S205 to S206 may be executed by changing order or may be performed in parallel.

Furthermore, the imaging device 300B may generate a third image including the first image 561 and the second image 562 by simultaneously imaging the display device 200 on which the chart image 550 is displayed and the actual color chart.

In this case, for example, the information processing device 100 can acquire the first image 561 and the second image 562 by cutting out a region including the display device 200 from the third image as the first image 561 and cutting out a region including the color chart as the second image 562.

### 6.2. Imaging Processing Example

FIG. 21 is a flowchart illustrating an example of a flow of imaging processing according to the embodiment of the present disclosure. The imaging processing illustrated in FIG. 21 is executed by, for example, the devices of the information processing system 10. Note that, here, a case in which the information processing device 100 corrects the background image 510 with the correction coefficient is explained. However, the information processing device 100 may apply the correction coefficient to at least one of the display device 200 and the light source 400B.

As illustrated in FIG. 21, the information processing device 100 corrects the background image 510 with the correction coefficient calculated by the calibration processing (Step S301).

The information processing device 100 causes the display device 200 to display the corrected background image 510 (the corrected background image) (Step S302). The imaging device 300B images the subject 600 and the display device 200 (Step S303).

Consequently, the information processing system 10 can acquire the corrected captured image and can acquire an image with higher reality.

### 7. Hardware Configuration

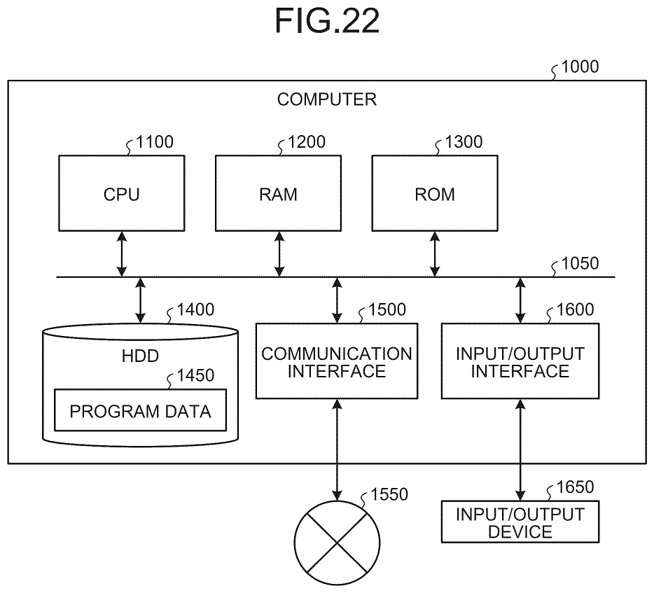

Information equipment such as the information processing device 100 according to the embodiment explained above is realized by, for example, a computer 1000 having a configuration illustrated in FIG. 22. The information processing device 100 according to the embodiment is explained as an example below. FIG. 22 is a hardware configuration diagram illustrating an example of the computer 1000 that implements the functions of the information processing device 100. The computer 1000 includes a CPU 1100, a RAM 1200, a ROM (Read Only Memory) 1300, an HDD (Hard Disk Drive) 1400, a communication interface 1500, and an input/output interface 1600. The units of the computer 1000 are connected by a bus 1050.

The CPU 1100 operates based on programs stored in the ROM 1300 or the HDD 1400 and controls the units. For example, the CPU 1100 loads the programs stored in the ROM 1300 or the HDD 1400 in the RAM 1200 and executes processing corresponding to various programs.

The ROM 1300 stores a boot program such as a BIOS (Basic Input Output System) executed by the CPU 1100 at a start time of the computer 1000, a program depending on hardware of the computer 1000, and the like.

The HDD 1400 is a computer-readable recording medium that non-transiently records a program to be executed by the CPU 1100, data to be used by such a program, and the like. Specifically, the HDD 1400 is a recording medium that records an audio reproduction program according to the present disclosure as an example of program data 1450.

The communication interface 1500 is an interface for the computer 1000 to be connected to an external network 1550 (for example, the Internet). For example, the CPU 1100 receives data from other equipment and transmits data generated by the CPU 1100 to the other equipment via the communication interface 1500.

The input/output interface 1600 is an interface for connecting an input/output device 1650 and the computer 1000. For example, the CPU 1100 receives data from an input device such as a keyboard or a mouse via the input/output interface 1600. The CPU 1100 transmits data to an output device such as a display, a speaker, or a printer via the input/output interface 1600. The input/output interface 1600 may function as a media interface that reads a program or the like recorded in a predetermined recording medium (a medium). The medium is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 1000 functions as the information processing device 100 according to the embodiment, the CPU 1100 of the computer 1000 implements the functions of the control unit 130 and the like by executing the information processing program loaded in the RAM 1200. The HDD 1400 stores the information processing program according to the present disclosure and the data in the storage unit 120. Note that the CPU 1100 reads the program data 1450 from the HDD 1400 and executes the program data 1450. However, as another example, the CPU 1100 may acquire these programs from another device via the external network 1550.

### 8. Other Embodiments

The embodiments explained above and modifications indicate examples, and various modifications and applications are possible.

For example, the control device that controls the information processing device 100 of the present embodiment may be realized by a dedicated computer system or may be realized by a general-purpose computer system.

For example, a communication program for executing the operation explained above is distributed by being stored in a computer-readable recording medium such as an optical disk, a semiconductor memory, a magnetic tape, or a flexible disk. Then, for example, the program is installed in a computer and the control device is configured by executing the processing explained above. At this time, the control device may be a device outside the information processing device 100 (for example, a personal computer). The control device may be a device (for example, the control unit 130) inside the information processing device 100.

The communication program explained above may be stored in a disk device included in a server device on a network such as the Internet such that the communication program can be downloaded to a computer. The functions explained above may be implemented by cooperation of an OS (Operating System) and application software. In this case, a portion other than the OS may be stored in a medium and distributed or the portion other than the OS may be stored in the server device such that the portion can be downloaded to the computer.

Among the kinds of processing explained in the embodiment, all or a part of the processing explained as being automatically performed can be manually performed or all or a part of the processing explained as being manually performed can be automatically performed by a publicly-known method. Besides, the processing procedures, the specific names, and the information including the various data and parameters explained in the document and illustrated in the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing the processing contents to contradict one another. In addition, the order of the steps illustrated in the flowchart and the like of the embodiment explained above can be changed as appropriate.

For example, the present embodiment can be implemented as any configuration configuring a device or a system, for example, a processor functioning as a system LSI (Large Scale Integration) or the like, a module using a plurality of processors or the like, a unit using a plurality of modules or the like, a set obtained by further adding other functions to the unit, and the like (that is, a configuration of a part of the device).

Note that, in the present embodiment, the system means a set of a plurality of components (devices, modules (parts), and the like) It does not matter whether all the components are present in the same housing. Therefore, both of a plurality of devices housed in separate housings and connected via a network and one device in which a plurality of modules are housed in one housing are systems.

For example, the present embodiment can adopt a configuration of cloud computing in which one function is shared and processed by a plurality of devices in cooperation via a network.

### 9. CONCLUSION

Although the embodiment of the present disclosure is explained above, the technical scope of the present disclosure is not limited to the embodiment as it is, and various modifications can be made without departing from the gist of the present disclosure. Components in different embodiments and modifications may be combined as appropriate.

The effects in the embodiments described in this specification are only illustrations and are not limited. Other effects may be present.

Note that the present technology can also take the following configurations.
(1)
   An information processing device comprising a control unit that, when a re-photographing image displayed on a display device disposed in an imaging environment is captured by an imaging device, calculates, based on a first image obtained when a display image displayed on the display device is captured by the imaging device and a second image obtained when the display image is captured by the imaging device in the imaging environment, a correction coefficient used to display the re-photographing image after correction on the display device.
(2)
   The information processing device according to (1), wherein the control unit calculates the correction coefficient for reducing a difference between a color of one of the first image and the second image corrected by the correction coefficient and the color of another of the first image and the second image.
(3)
   The information processing device according to (1) or (2), wherein the first image is a captured image obtained by imaging, with the imaging device, the display image displayed on the display device disposed in the imaging environment.
(4)
   The information processing device according to (1) or (2), wherein the control unit generates the first image according to a spectral characteristic of the display device and a characteristic of the imaging device.
(5)
   The information processing device according to (4), wherein the control unit acquires the spectral characteristic of the display device from the display device.
(6)
   The information processing device according to (4) or (5), wherein the control unit acquires the characteristic of the imaging device from the imaging device.
(7)
   The information processing device according to any one of (1) to (6), wherein the second image is a captured image captured by the imaging device in the imaging environment.
(8)
   The information processing device according to any one of (1) to (6), wherein the control unit generates the second image according to a spectral characteristic of a light source in the imaging environment and a characteristic of the imaging device.
(9)
   The information processing device according to (8), wherein the control unit acquires the spectral characteristic of the light source from the light source.
(10)
   The information processing device according to (8) or (9), wherein the control unit acquires the characteristic of the imaging device from the imaging device.
(11)
   The information processing device according to any one of (1) to (10), wherein
   the correction coefficient includes a first coefficient and a second coefficient,
   the first coefficient is calculated based on the display image and the first image, and
   the second coefficient is calculated based on a reference image including an object included in the second image and the second image.
(12)
   The information processing device according to (11), wherein
   the first coefficient is used for correction of the re-the second coefficient is used for correction of a light source disposed in the imaging environment.
(13)
   The information processing device according to any one of (1) to (12), wherein the control unit causes a second display device to display at least one of the first image and the second image.
(14)
   The information processing device according to any one of (1) to (13), wherein the control unit causes a second display device to display at least one of a color included in the first image and color difference information concerning a difference of the color included in the second image.
(15)
   The information processing device according to any one of (1) to (14), wherein the control unit causes a second display device to display at least one of a corrected captured image captured by the imaging device by applying the correction coefficient and a captured image captured by the imaging device without applying the correction coefficient.
(16)
   The information processing device according to any one of (1) to (15), wherein the control unit detects a sample color based on color chart information included in at least one of the first image and the second image.
(17)
   The information processing device according to any one of (1) to (16), wherein the control unit detects sample color information included in at least one of the first image and the second image.
(18)
   A program for causing a computer to execute, when a re-photographing image displayed on a display device disposed in an imaging environment is captured by an imaging device, calculating, based on a first image obtained when a display image displayed on the display device is captured by the imaging device and a second image obtained when the display image is captured by the imaging device in the imaging environment, a correction coefficient used to display the re-photographing image after correction on the display device.
(19)
   An information processing system comprising:
   an information processing device;
   a display device disposed in an imaging environment; and
   an imaging device that images the imaging environment including the display device, wherein
   the information processing device includes
   a control unit that, when a re-photographing image displayed on the display device disposed in the imaging environment is captured by the imaging device, calculates, based on a first image obtained when a display image displayed on the display device is captured by the imaging device and a second image obtained when the display image is captured by the imaging device in the imaging environment, a correction coefficient used to display the re-photographing image after correction on the display device.

### REFERENCE SIGNS LIST

10 INFORMATION PROCESSING SYSTEM
100 INFORMATION PROCESSING DEVICE
110 COMMUNICATION UNIT
120 STORAGE UNIT
130 CONTROL UNIT
140 DISPLAY UNIT
200 DISPLAY DEVICE
300 IMAGING DEVICE
400 LIGHT SOURCE

1. An information processing device comprising
a control unit that, when a re-photographing image displayed on a display device disposed in an imaging environment is captured by an imaging device, calculates, based on a first image obtained when a display image displayed on the display device is captured by the imaging device and a second image obtained when the display image is captured by the imaging device in the imaging environment, a correction coefficient used to display the re-photographing image after correction on the display device.

2. The information processing device according to claim 1, wherein the control unit calculates the correction coefficient for reducing a difference between a color of one of the first image and the second image corrected by the correction coefficient and the color of another of the first image and the second image.

3. The information processing device according to claim 1, wherein the first image is a captured image obtained by imaging, with the imaging device, the display image displayed on the display device disposed in the imaging environment.

4. The information processing device according to claim 1, wherein the control unit generates the first image according to a spectral characteristic of the display device and a characteristic of the imaging device.

5. The information processing device according to claim 4, wherein the control unit acquires the spectral characteristic of the display device from the display device.

6. The information processing device according to claim 4, wherein the control unit acquires the characteristic of the imaging device from the imaging device.

7. The information processing device according to claim 1, wherein the second image is a captured image captured by the imaging device in the imaging environment.

8. The information processing device according to claim 1, wherein the control unit generates the second image according to a spectral characteristic of a light source in the imaging environment and a characteristic of the imaging device.

9. The information processing device according to claim 8, wherein the control unit acquires the spectral characteristic of the light source from the light source.

10. The information processing device according to claim 8, wherein the control unit acquires the characteristic of the imaging device from the imaging device.

11. The information processing device according to claim 1, wherein
the correction coefficient includes a first coefficient and a second coefficient,
the first coefficient is calculated based on the display image and the first image, and
the second coefficient is calculated based on a reference image including an object included in the second image and the second image.

12. The information processing device according to claim 11, wherein
the first coefficient is used for correction of the re-photographing image, and
the second coefficient is used for correction of a light source disposed in the imaging environment.

13. The information processing device according to claim 1, wherein the control unit causes a second display device to display at least one of the first image and the second image.

14. The information processing device according to claim 1, wherein the control unit causes a second display device to display at least one of a color included in the first image and color difference information concerning a difference of the color included in the second image.

15. The information processing device according to claim 1, wherein the control unit causes a second display device to display at least one of a corrected captured image captured by the imaging device by applying the correction coefficient and a captured image captured by the imaging device without applying the correction coefficient.

16. The information processing device according to claim 1, wherein the control unit detects a sample color based on color chart information included in at least one of the first image and the second image.

17. The information processing device according to claim 1, wherein the control unit detects sample color information included in at least one of the first image and the second image.

18. A program for causing a computer to execute,
when a re-photographing image displayed on a display device disposed in an imaging environment is captured by an imaging device, calculating, based on a first image obtained when a display image displayed on the display device is captured by the imaging device and a second image obtained when the display image is captured by the imaging device in the imaging environment, a correction coefficient used to display the re-photographing image after correction on the display device.

19. An information processing system comprising:
an information processing device;
a display device disposed in an imaging environment; and
an imaging device that images the imaging environment including the display device, wherein
the information processing device includes
a control unit that, when a re-photographing image displayed on the display device disposed in the imaging environment is captured by the imaging device, calculates, based on a first image obtained when a display image displayed on the display device is captured by the imaging device and a second image obtained when the display image is captured by the imaging device in the imaging environment, a correction coefficient used to display the re-photographing image after correction on the display device.
